(19) United States
(12) Patent Application Publication
(10) Pub. No.: US 2007/0277088 A1
(43) Pub. Date: Nov. 29, 2007

(54) ENHANCING AN EXISTING WEB PAGE

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/420,014

(22) Filed: May 24, 2006

(51) Int. Cl. G06F 17/00

(52) U.S. Cl. 715/501.1

(57) ABSTRACT

Methods, systems, and computer program products are provided for enhancing an existing web page. Embodiments include retrieving a web page; identifying a hyperlink within the web page; retrieving content by invoking the hyperlink; creating a speech presentation of the content accessible through the hyperlink; storing the speech presentation; creating a new hyperlink to the speech presentation; and augmenting the web page to include the new hyperlink.

### BACKGROUND OF THE INVENTION

1. Field of the Invention

The field of the invention is data processing, or, more specifically, methods, systems, and products for enhancing an existing web page.

2. Description of Related Art

Conventional web pages often include hyperlinks to other content. Such web pages are typically displayed on a browser installed on a computer that also supports one or more digital media player applications for playing audio. Despite the fact that conventional web pages are displayed on computers that support playing audio, conventional web pages do not make existing content available through their hyperlinks also available as a speech presentation for audio rendering. There is therefore an ongoing need for improvement in enhancing an existing web page.

### SUMMARY OF THE INVENTION

Methods, systems, and computer program products are provided for enhancing an existing web page. Embodiments include retrieving a web page; identifying a hyperlink within the web page; retrieving content by invoking the hyperlink; creating a speech presentation of the content accessible through the hyperlink; storing the speech presentation; creating a new hyperlink to the speech presentation; and augmenting the web page to include the new hyperlink.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for enhancing an existing web page according to embodiments of the present invention.

FIG. 2 sets forth a block diagram depicting a system for enhancing an existing web page according to the present invention.

FIG. 3 sets forth a block diagram of automated computing machinery comprising an exemplary consolidated content management server useful in enhancing an existing web page according to embodiments of the present invention.

FIG. 4 sets a block diagram of automated computing machinery comprising an exemplary computer useful in enhancing an existing web page in accordance with the present invention.

FIG. 5 sets forth a flow chart illustrating an exemplary method for enhancing an existing web page.

FIG. 6 sets forth a flow chart illustrating an exemplary method for creating a speech presentation of the content accessible through one or more hyperlinks in the existing web page.

FIG. 7 sets forth a block diagram illustrating a web page enhanced according to the present invention.

### DETAILED DESCRIPTION OF EXEMPLARY EMBODIMENTS

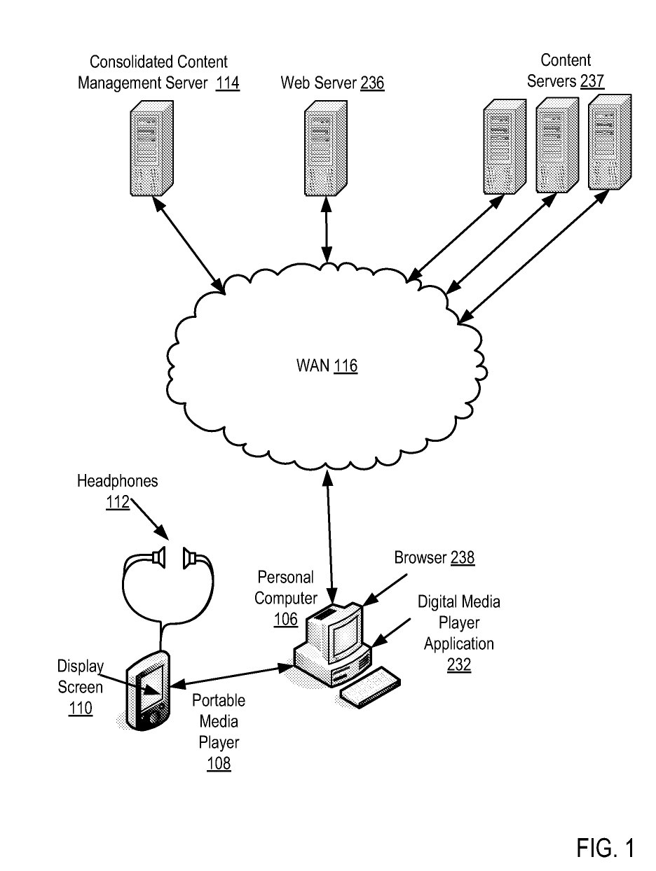

Exemplary methods, systems, and products for enhancing an existing web page are described with reference to the accompanying drawings, beginning with FIG. 1. FIG. 1 sets forth a network diagram illustrating an exemplary system for enhancing an existing web page according to embodiments of the present invention. The system of FIG. 1 is capable of enhancing an existing web page by retrieving a web page; identifying a hyperlink within the web page; retrieving content by invoking the hyperlink; creating a speech presentation of the content accessible through the hyperlink; storing the speech presentation; creating a new hyperlink to the speech presentation; and augmenting the web page to include the new hyperlink.

The system of FIG. 1 includes a consolidated content management server (114) coupled for data communications with a personal computer (106), a web server (236), and a plurality of content servers (237) through a wide area network (116) (‘WAN’). The consolidated content management server (114) of FIG. 1 includes computer program instructions capable of retrieving a web page from the web server (236); identifying within the web page one or more hyperlinks to content on one or more content servers (237); retrieving content from the one or more content servers (237) by invoking the one or more hyperlinks; creating a speech presentation of the content accessible through the hyperlink and retrieved from the content servers (237); storing the speech presentation created from the content; creating a new hyperlink to the speech presentation; and augmenting the web page to include the new hyperlink.

The example of FIG. 1 illustrates three content servers (237) from which content is accessible through one or more hyperlinks in a web page retrieved from the web server (236). The content provided by the content servers may be in various forms. For example, content available through hyperlinks one content servers may include word processing documents, spreadsheets, web pages, or content in any other form that will occur to those of skill in the art.

The use of three content servers in the example of FIG. 1 is for explanation and not for limitation. In fact, web servers typically serve up web pages that may include hyperlinks to content on any number of servers. Such hyperlinks may point to content such as files in file system, web pages, content in a database, or any other content that will occur to those of skill in the art.

Furthermore, the use of content servers in the example of FIG. 1 is for explanation and not for limitation. In fact, hyperlinks in web pages may point to content that resides locally on a consolidated content management server or a local personal computer capable of enhancing an existing web page according to the present invention.

In the example of FIG. 1, the personal computer (106) has installed upon it a browser (238) capable of downloading from the consolidated content management server (114) the enhanced web page having new hyperlinks to speech presentation of content. ‘Browser,’ as the term is used in this specification, generally means a web browser, a software application for locating, requesting, retrieving, and displaying computer resources in the form of static or dynamic web pages or server-side scripting output. Browsers typically comprise both a markup language interpreter, web page display routines, and an HTTP communications client. Typical browsers today can display text, graphics, audio and video. Browsers are operative in any computer capable of data communications including web-enabled devices, wireless web-enabled devices, microcomputers, PDAs, laptops, and so on. Browsers in wireless web-enabled devices often are downsized browsers called “microbrowsers.” Browsers typically support not only HTML (the ‘HyperText Markup Language’), but other markup languages as well, including for example, XML (the ‘eXtensible Markup Language’), and, in the case of wireless web-enabled devices, WML (the ‘Wireless Markup Language’) and HDML (the ‘Handheld Device Markup Language’).

The personal computer (106) of FIG. 1 also has installed upon it a digital media player application (232). A digital media player application (232) is an application that manages media content such as audio files and video files. Such digital media player applications are typically capable of transferring supported media files to a portable media player. Examples of digital media player applications include Music Match™, iTunes® and others as will occur to those of skill in the art.

The digital media player application (232) of FIG. 1 is capable of storing a media file containing the speech presentation on a portable media player (108). A portable media player is a device, typically handheld, capable of rendering media files such as audio or video files. In the example of FIG. 1, the portable media player (108) includes a display screen (110) for rendering video and headphones (112) for rendering audio. Examples of portable media players include the iPod® from Apple and Creative Zen Vision from Creative labs.

Storing the media files including the speech presentation of the content accessible through the hyperlinks in the web page on a portable media player advantageously allows a user to render as speech content that is conventionally accessible only through hyperlinks and conventionally rendered on a browser. Rendering the content as speech on a digital media player provides users increased flexibility in accessing the content.

In the example of FIG. 1, the consolidated content management server (114) of FIG. 1 enhances an existing web page according to the present invention. This is for explanation, and not for limitation. In fact, systems for enhancing an existing web page according to the present invention may be implemented in less distributed environments or in more distributed environments. The servers serving up a web page including one or more hyperlinks, the content servers containing the content pointed to by the hyperlinks, the modules for enhancing an existing web page, and the digital media player application for transferring the speech presentation to a portable digital media player may reside in a single computer, or in distributed environment of varying scope.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

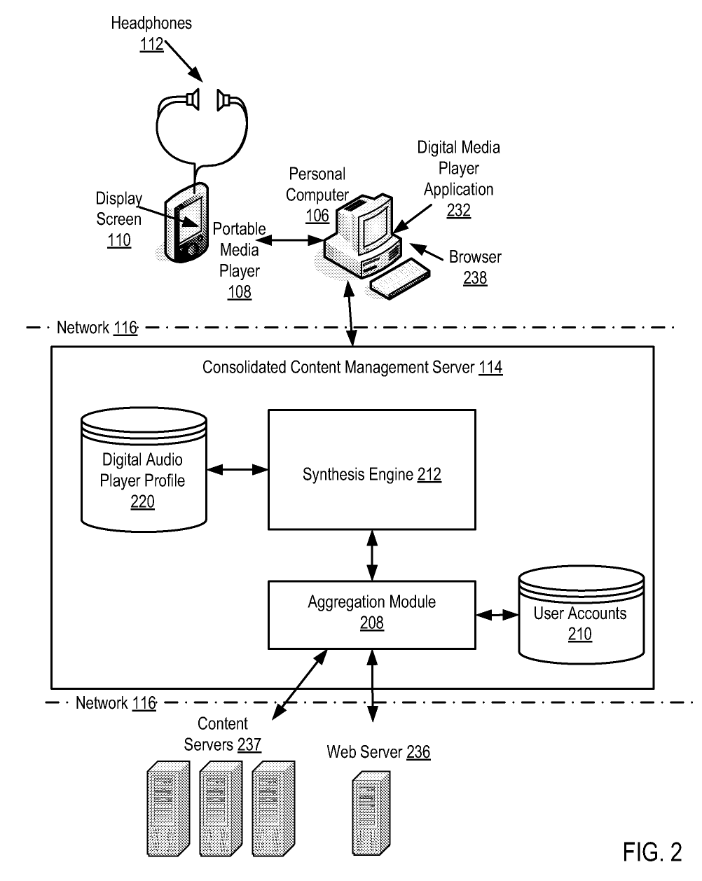

For further explanation, FIG. 2 sets forth a block diagram depicting a system for enhancing an existing web page according to the present invention. The system of FIG. 2 includes a portable media player (108). The portable media player is capable of playing media files containing speech presentations created from content identified by one or more hyperlinks in a web page retrieved from a web server (236). The system of FIG. 2 also includes a digital media player application (232). The digital media player application (232) of FIG. 2 is capable of storing a media file containing such a speech presentation on a portable media player.

The system of FIG. 2 also includes a personal computer (106). The personal computer (106) of FIG. 2 has installed upon it a browser (238). The browser (238) of FIG. 2 is capable of downloading a web page enhanced according to the present invention from a consolidated content management server (114) and displaying the enhanced web page.

The system of FIG. 2 includes a consolidated content management server (114). The consolidated content management server (114) of FIG. 2 is capable of enhancing an existing web page according to the present invention by retrieving a web page; identifying a hyperlink within the web page; retrieving content by invoking the hyperlink; creating a speech presentation of the content accessible through the hyperlink; storing the speech presentation; creating a new hyperlink to the speech presentation; and augmenting the web page to include the new hyperlink.

The consolidated content management server (114) of FIG. 2 includes an aggregation module (208). The aggregation module (208) of FIG. 2 is implemented as computer program instructions for retrieving a web page. The exemplary aggregation module (208) is capable generally of retrieving a web page for enhancement according to the present invention in response to a user instruction received through, for example, a browser installed on a personal computer or without specific user instruction in accordance with an associated user account (210). Such a user account (210) typically includes user information such as a user ID, identifications of web servers identified by a user, and rules governing the retrieval of web pages for enhancement according to the present invention.

The consolidated content management server (114) of FIG. 2 also includes a synthesis engine (212). The synthesis engine of FIG. 2 is implemented as computer program instructions for identifying one or more hyperlinks within the web page; retrieving content from one or more content servers (237) by invoking the hyperlink; creating a speech presentation of the content accessible through the hyperlink; storing the speech presentation; creating a new hyperlink to the speech presentation; and augmenting the web page to include the new hyperlink. The speech presentations are typically created and stored in a media file in a data format compatible with the portable media player (108). The synthesis engine (212) of Figure therefore creates a media file including the speech presentation of the content retrieved from one or more of the content servers (237) in a data format identified in a portable media player profile (220) maintained by the consolidated content management server (114). Portable media player profiles typically include an identification of the target portable media player and an identification of one or more media file formats that the target portable media player supports.

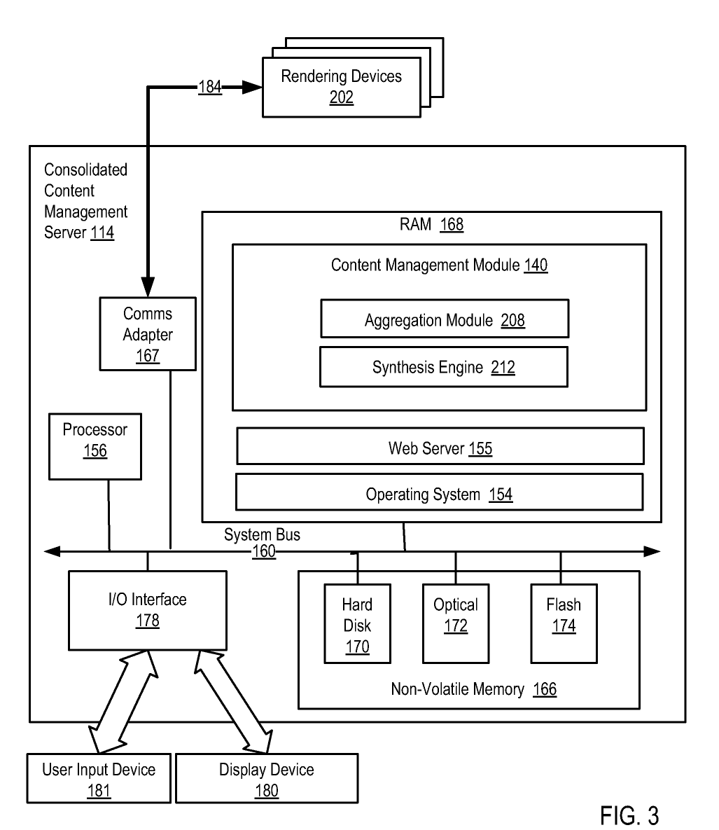

Enhancing an existing web page in accordance with the present invention is generally implemented with computers, that is, with automated computing machinery. In the systems of FIGS. 1 and 2, for example, all the nodes, servers, and communications devices are implemented to some extent at least as computers. For further explanation, therefore, FIG. 3 sets forth a block diagram of automated computing machinery comprising an exemplary consolidated content management server (114) useful in enhancing an existing web page according to embodiments of the present invention. The consolidated content management server (114) of FIG. 3 includes at least one computer processor (156) or ‘CPU’ as well as random access memory (168) (‘RAM’) which is connected through a system bus (160) to a processor (156) and to other components of the consolidated content management server (114).

Stored in RAM (168) is an exemplary consolidated content management module (140), computer program instructions for enhancing an existing web page. The consolidated content management module (140) of FIG. 3 includes an aggregation module (208), computer program instructions for retrieving a web page. The exemplary aggregation module (208) is capable generally of retrieving a web page for enhancement according to the present invention in response to a user instruction through, for example, a browser installed on a remote personal computer or without specific user instruction in accordance with an associated user account. Such a user account typically includes user information such as a user ID, identifications of web servers identified by a user, and rules governing the retrieval of web pages for enhancement according to the present invention.

The consolidated content management module (140) of FIG. 2 also includes a synthesis engine (212) computer program instructions for identifying one or more hyperlinks within the web page; retrieving content from one or more content servers by invoking the hyperlink; creating a speech presentation of the content accessible through the hyperlink; storing the speech presentation; creating a new hyperlink to the speech presentation; and augmenting the web page to include the new hyperlink. The speech presentations are typically created and stored in a media file in a data format compatible with the portable media player (108). The synthesis engine (212) of FIG. 2 therefore creates a media file including the speech presentation of the content retrieved from one or more of the content servers (237) in a data format identified in a portable media player profile (220) maintained by the consolidated content management server (114). Portable media player profiles typically include an identification of the target portable media player and an identification of one or more media file formats that the target portable media player supports.

The exemplary consolidated content management server (114) of FIG. 3 also includes a web server (155). The consolidated content management server may usefully enhance an existing web page through the use of programs that run on a web server and build web pages, such as for example, servlets. Such programs may build dynamic server pages such as for example Java Server Pages (‘JSP’). One such web server useful in enhancing an existing web page according to the present invention is the WebSphere® Application Server available from IBM. WebSphere Application Server is a Java™-based application platform, integrating enterprise data and transactions for the dynamic e-business. WebSphere Application Server delivers a rich application deployment environment with application services that provide transaction management, security, performance, availability, connectivity, and scalability.

Also stored in RAM (168) is an operating system (154). Operating systems useful in computers according to embodiments of the present invention include UNIX™, Linux™, Microsoft Windows NT™, AIX™, IBM's i5/OS™, and others as will occur to those of skill in the art.

The exemplary consolidated content management server (114) of FIG. 3 includes non-volatile computer memory (166) coupled through a system bus (160) to a processor (156) and to other components of the consolidated content management server (114). Non-volatile computer memory (166) may be implemented as a hard disk drive (170), an optical disk drive (172), an electrically erasable programmable read-only memory space (so-called ‘EEPROM’ or ‘Flash’ memory) (174), RAM drives (not shown), or as any other kind of computer memory as will occur to those of skill in the art.

The exemplary consolidated content management server (114) of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary consolidated content management server (114) of FIG. 3 includes a communications adapter (167) for implementing data communications (184) with rendering devices (202). Such data communications may be carried out serially through RS-232 connections, through external buses such as a USB, through data communications networks such as IP networks, and in other ways as will occur to those of skill in the art. Communications adapters implement the hardware level of data communications through which one computer sends data communications to another computer, directly or through a network. Examples of communications adapters useful in the present invention include modems for wired dial-up communications, Ethernet (IEEE 802.3) adapters for wired network communications, and 802.11b adapters for wireless network communications and other as will occur to those of skill in the art.

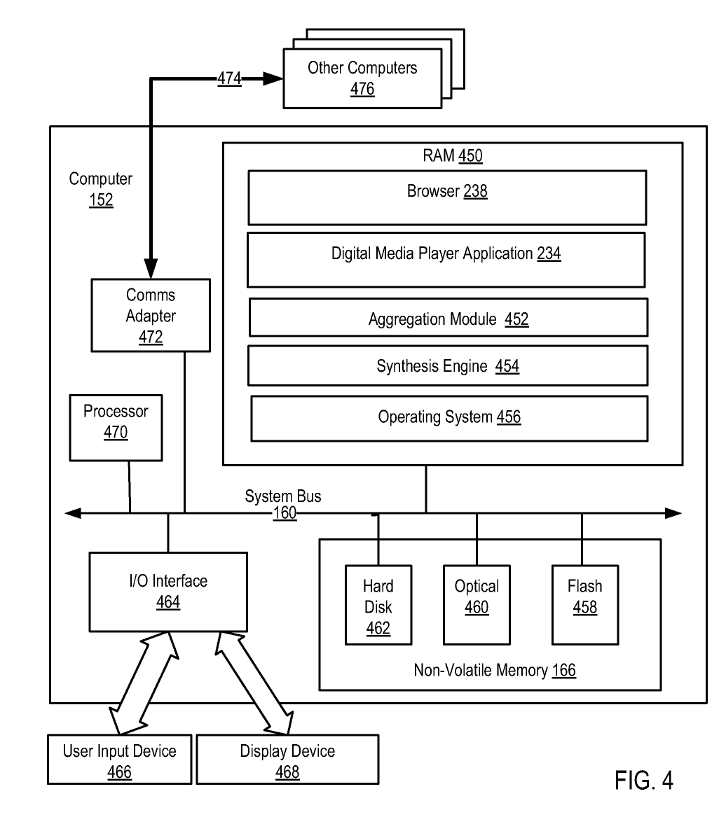

As discussed above, to display the enhanced web page to a user, the enhanced web page is typically downloaded to a browser installed on a computer and the speech presentation of the content accessible through the new hyperlinks in the enhanced web page may be stored on a portable digital media player. For further explanation, therefore, FIG. 4 sets a block diagram of automated computing machinery comprising an exemplary computer (152) useful in enhancing an existing web page in accordance with the present invention. The computer (152) of FIG. 4 includes at least one computer processor (470) or ‘CPU’ as well as random access memory (450) (‘RAM’) which is connected through a system bus (160) to processor (470) and to other components of the computer. Stored in RAM (450) is an operating system (456). Operating systems useful in computers according to embodiments of the present invention include UNIX™, Linux™, Microsoft XP™, AIX™, IBM's i5/OS™, and others as will occur to those of skill in the art.

Also stored in RAM (450) is a digital media player application (234). A digital media player application (234) is an application that manages media content in media files such as audio files and video files. Such digital media player applications are typically capable of transferring media files to a portable media player. Examples of digital media player applications include Music Match™, iTunes® and others as will occur to those of skill in the art. The digital media player application (234) of FIG. 4 is capable of storing a media file containing a speech presentation of content accessible through a new hyperlink in the enhanced web page.

The example of FIG. 4 includes a browser (238). As discussed above, a generally means a web browser, a software application for locating, requesting, retrieving, and displaying computer resources in the form of static or dynamic web pages or server-side scripting output. Browsers typically comprise both a markup language interpreter, web page display routines, and an HTTP communications client.

As discussed above, enhancing an existing web page according to the present invention is not limited to the distributed environments depicted in the examples of FIGS. 1 and 2. In fact, enhancing an existing web page may be usefully carried out using a single computer. In the example of FIG. 4, therefore, also stored in RAM is an aggregation module (452) computer program instructions for retrieving a web page for enhancement according to the present invention in response to a user instruction through, for example, a browser (238) or without specific user instruction in accordance with an associated user account. Such a user account typically includes user information such as a user ID, identifications of web servers identified by a user, and rules governing the retrieval of web pages for enhancement according to the present invention.

Also stored in RAM is a synthesis engine (454) computer program instructions for identifying one or more hyperlinks within the web page; retrieving content from one or more content servers by invoking the hyperlink; creating a speech presentation of the content accessible through the hyperlink; storing the speech presentation; creating a new hyperlink to the speech presentation; and augmenting the web page to include the new hyperlink. The speech presentations are typically created and stored in a media file in a data format compatible with the portable media player. The synthesis engine (454) of FIG. 4 therefore creates a media file including the speech presentation of the content retrieved from one or more of the content servers (237) in a data format identified in a portable media player profile maintained by the consolidated content management server. Portable media player profiles typically include an identification of the target portable media player and an identification of one or more media file formats that the target portable media player supports.

The operating system (456), digital media player application (234), aggregation module (452), synthesis engine (454) and the browser (238) in the example of FIG. 4 are shown in RAM (450), but many components of such software may be stored in non-volatile memory (166) also.

Computer (152) of FIG. 4 includes non-volatile computer memory (166) coupled through a system bus (160) to processor (470) and to other components of the computer (152). Non-volatile computer memory (166) may be implemented as a hard disk drive (462), optical disk drive (460), electrically erasable programmable read-only memory space (so-called ‘EEPROM’ or ‘Flash’ memory) (458), RAM drives (not shown), or as any other kind of computer memory as will occur to those of skill in the art.

The example computer of FIG. 4 includes one or more input/output interface adapters (464). Input/output interface adapters in computers implement user-oriented input/output through, for example, software drivers and computer hardware for controlling output to display devices (468) such as computer display screens, as well as user input from user input devices (466) such as keyboards and mice.

The exemplary computer (152) of FIG. 4 includes a communications adapter (472) for implementing data communications (474) with other computers (476). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in embodiments of the present invention include modems for wired dial-up communications, Ethernet (IEEE 802.3) adapters for wired network communications, and 802.11b adapters for wireless network communications.

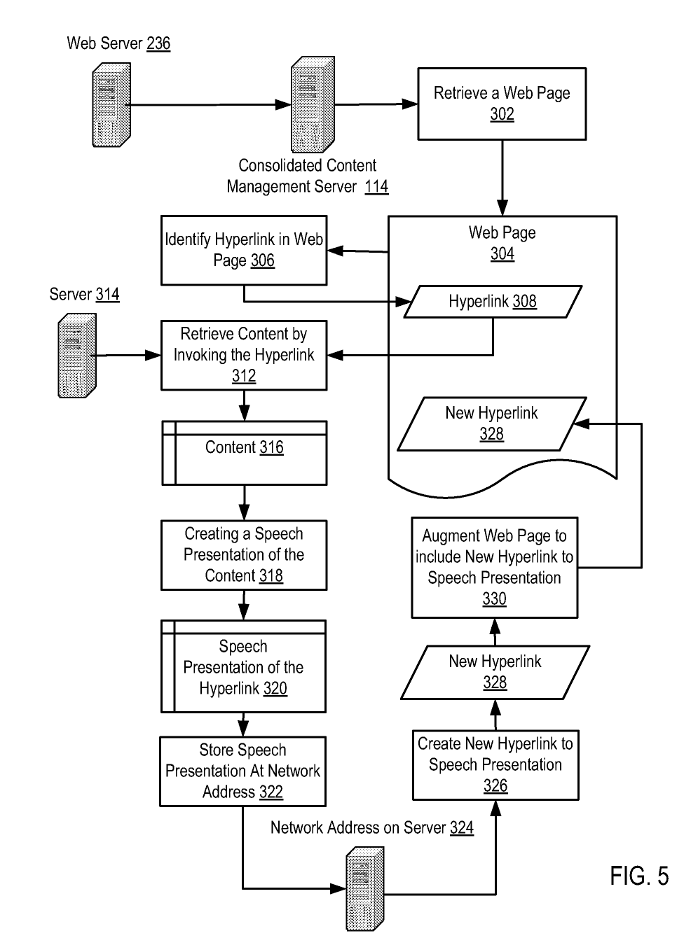

For further explanation, FIG. 5 sets forth a flow chart illustrating an exemplary method for enhancing an existing web page. The method of FIG. 5 includes retrieving (302) a web page (304). In the example of FIG. 5, retrieving (302) a web page (304) is carried out by a consolidated content management server (114). The specific web page to be retrieved by the consolidated content management server may be identified by a user through for example a browser installed on a remote computer. Consolidated content management server may therefore provide a single point of access for web pages enhanced according to the present invention from web pages retrieved from any number of web servers identified in real time by a user or identified in dependence upon other user information, such as that stored in a user account.

The method of FIG. 5 also includes identifying (306) a hyperlink (308) within the web page (304) and retrieving (312) content (316) by invoking the hyperlink (308). A ‘hyperlink’ is a reference to a URL which when invoked requests access to a resource identified by the URL. The term ‘hyperlink’ in this specification includes links to URLs effected through anchor elements in web pages. An anchor element is a markup language element that identifies and implements a hyperlink. An exemplary form of an anchor element, here expressed in HTML, is:
<a href=“\\SrvrX\DocY”> Press Here For Document Y </a>

This example anchor element includes a start tag <a>, and end tag </a>, an href attribute that identifies the target of the link as a document named ‘DocY’ on a web server named ‘SrvrX,’ and an anchor. The “anchor” is the display text that is set forth between the start tag and the end tag. That is, in this example, the anchor is the text “Press Here For Document Y.” In typical usage, the anchor is displayed in highlighting, underscored, inverse, specially colored, or some other fashion setting it apart from other screen text and identifying it as an available hyperlink. In addition, the screen display area of the anchor is often sensitized to user interface operations such as GUI pointer operations such as mouseclicks. In typical operation, a user points to the anchor with a mouse pointer or other GUI pointer, clicks on the anchor to invoke the link, and the browser then retrieves and displays Document Y from server SrvrX. The ‘anchor element’ is the entire markup from the start tag to the end tag.

Identifying a hyperlink within the web page according to the method of FIG. 5 may therefore be carried out by searching the hyperlink for an href element in the web page. Retrieving content by invoking the hyperlink according to the method of FIG. 5 may be carried out by identifying a network address associated with the href element and retrieving the content from a server (314) associated with the network address.

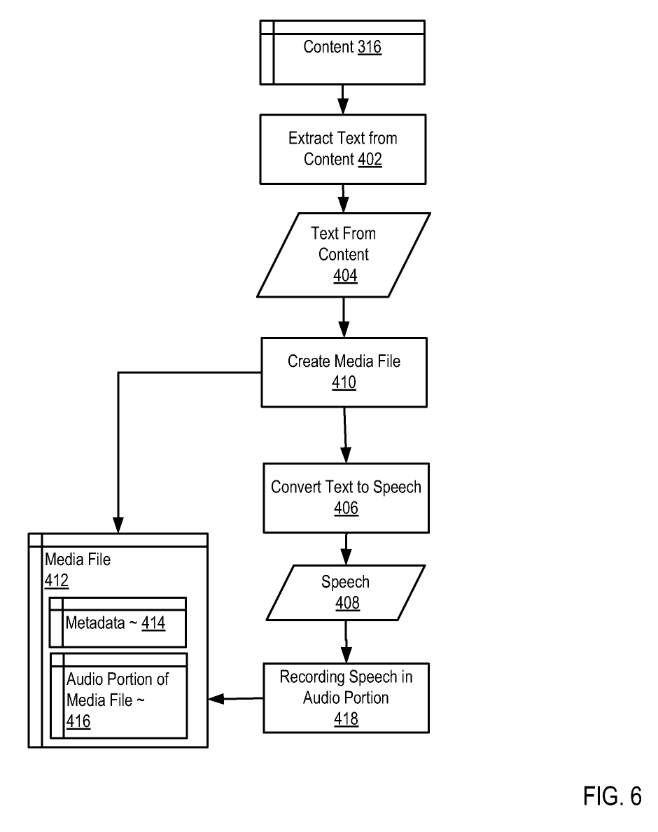

The method of FIG. 5 also includes creating (318) a speech presentation (320) of the content (316) accessible through the hyperlink (308). Creating (318) a speech presentation (320) of the content (316) accessible through the hyperlink (308) may be carried out by extracting text from the content; converting the text to speech; creating a media file; and recording the speech in the audio portion of the media file as discussed below with reference to FIG. 6.

The method of FIG. 5 also includes storing (322) the speech presentation (320). Storing (322) the speech presentation (320) may be carried out by storing a media file containing the speech presentation at a network address.

The method of FIG. 5 also includes creating (326) a new hyperlink (328) to the speech presentation (320). Creating (326) a new hyperlink (328) to the speech presentation (320) may be carried out by creating an anchor element in the markup language of the web page.

The method of FIG. 5 also includes augmenting (330) the web page (304) to include the new hyperlink (328). Augmenting (330) the web page (304) to include the new hyperlink (328) may be carried out by including in the web page a newly created anchor element.

The method of FIG. 5 may also include making the augmented web page available at a network address. Making the augmented web page available at a network address advantageously allows the enhanced web page to be downloaded to web browsers thereby providing users access to the speech presentation of content available through the new hyperlinks in the enhanced web page.

As discussed above, enhancing an existing web page includes creating a speech presentation of content accessible through one or more hyperlinks in the existing web page. For further explanation, therefore, FIG. 6 sets forth a flow chart illustrating an exemplary method for creating a speech presentation of the content accessible through one or more hyperlinks in the existing web page. The method of FIG. 6 includes extracting (402) text (404) from the content (316). As discussed above, the content accessible through the hyperlink may be in various forms. For example, the content may be a word processing document, a spreadsheet, a web page, or content in any other form that will occur to those of skill in the art. Extracting (402) text (404) from the content (316) contained in a web page or other markup document accessible through a browser, for example, may be carried out by identifying display text from markup in the document dictating the text for display by a browser. Extracting text from the content in a web page or markup document therefore may be carried out by retrieving display text from a web page or markup document. Such extracted display text implements some or all of the substantive text content of the web page or markup document.

The example above describing extracting text from a web page is for explanation and not for limitation. As discussed above, the content accessible through the hyperlink may be in various forms. For example, the content may be a word processing document, a spreadsheet, a web page, or content in any other form that will occur to those of skill in the art. Extracting text from the content therefore may be carried out by extracting text from content in word processing documents, spreadsheets, and content in other forms as will occur to those of skill in the art.

The method of FIG. 6 also includes creating (410) a media file (412). Examples of media files include MPEG 3 (‘.mp3’) files, MPEG 4 (‘.mp4’) files, Advanced Audio Coding (‘AAC’) compressed files, Advances Streaming Format (‘ASF’) Files, WAV files, and many others as will occur to those of skill in the art. Creating a media file typically includes creating a media file that is supported by a digital media player application installed on a computer or portable digital media player upon which the speech presentation of the content is to be rendered.

The method of FIG. 6 also includes converting (406) the text (404) to speech (408) and recording (418) the speech (408) in the audio portion (416) of the media file (412). Converting the text to speech and recording the speech in the audio portion of the media file may be carried out by processing the extracted text using a text-to-speech engine in order to produce a speech presentation of the extracted text and then recording the speech produced by the text-speech-engine in the audio portion of a media file. Examples of speech engines capable of converting extracted text to speech for recording in the audio portion of a media file include, for example, IBM's ViaVoice Text-to-Speech, Acapela Multimedia TTS, AT&T Natural Voices™ Text-to-Speech Engine, and Python's pyTTS class. Each of these text-to-speech engines is composed of a front end that takes input in the form of text and outputs a symbolic linguistic representation to a back end that outputs the received symbolic linguistic representation as a speech waveform.

Typically, speech synthesis engines operate by using one or more of the following categories of speech synthesis: articulatory synthesis, formant synthesis, and concatenative synthesis. Articulatory synthesis uses computational biomechanical models of speech production, such as models for the glottis and the moving vocal tract. Typically, an articulatory synthesizer is controlled by simulated representations of muscle actions of the human articulators, such as the tongue, the lips, and the glottis. Computational biomechanical models of speech production solve time-dependent, 3-dimensional differential equations to compute the synthetic speech output. Typically, articulatory synthesis has very high computational requirements, and has lower results in terms of natural-sounding fluent speech than the other two methods discussed below.

Formant synthesis uses a set of rules for controlling a highly simplified source-filter model that assumes that the glottal source is completely independent from a filter which represents the vocal tract. The filter that represents the vocal tract is determined by control parameters such as formant frequencies and bandwidths. Each formant is associated with a particular resonance, or peak in the filter characteristic, of the vocal tract. The glottal source generates either stylized glottal pulses for periodic sounds and generates noise for aspiration. Formant synthesis generates highly intelligible, but not completely natural sounding speech. However, formant synthesis has a low memory footprint and only moderate computational requirements.

Concatenative synthesis uses actual snippets of recorded speech that are cut from recordings and stored in an inventory or voice database, either as waveforms or as encoded speech. These snippets make up the elementary speech segments such as, for example, phones and diphones. Phones are composed of a vowel or a consonant, whereas diphones are composed of phone-to-phone transitions that encompass the second half of one phone plus the first half of the next phone. Some concatenative synthesizers use so-called demi-syllables, in effect applying the diphone method to the time scale of syllables. Concatenative synthesis then strings together, or concatenates, elementary speech segments selected from the voice database, and, after optional decoding, outputs the resulting speech signal. Because concatenative systems use snippets of recorded speech, they have the highest potential for sounding like natural speech, but concatenative systems require large amounts of database storage for the voice database.

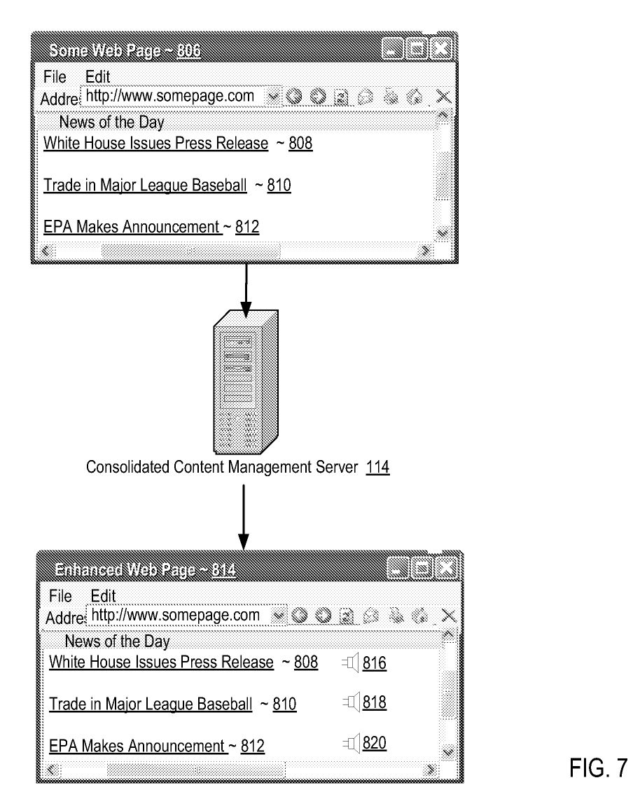

For further explanation, FIG. 7 sets forth a block diagram illustrating a web page enhanced according to the present invention. In the example of FIG. 7, a consolidated content management server enhances an existing web page (806) according to the present invention resulting in an enhanced web page (814). In the example of FIG. 7, a consolidated content management server enhances an existing web page by retrieving a web page entitled ‘Some Web Page’ (806) and identifying three hyperlinks (808, 810, and 812) within the web page (806). The hyperlink include a link to an article entitled ‘White House Issues Press Release’ (808), an article entitled ‘Trade in Major League Baseball’ (810), and an article entitled ‘EPA Makes Announcement’ (812).

In the example of FIG. 7, the consolidated content management server (114) enhances the web page (806) to create the enhanced web page (814) by retrieving the articles entitled ‘White House Issues Press Release,’ the article entitled ‘Trade in Major League Baseball,’ and the article entitled ‘EPA Makes Announcement’ by invoking the hyperlinks (808, 810, and 812). The consolidated content management server (114) also creates the enhanced web page (814) by creating a speech presentation of the articles accessible through the hyperlinks (808, 810, and 812), storing the speech presentations; creating new hyperlinks to the speech presentations; and augmenting the web page (814) to include the new hyperlinks (816, 818, and 820).

The consolidated content management server augments the web page (814) to include the new hyperlinks by including icons (816, 818, and 820) within the enhanced web page. The enhanced web page (814) of FIG. 7 includes an icon (816) that provides a hyperlink to a speech presentation of the article entitled ‘White House Issues Press Release.’ The enhanced web page (814) of FIG. 7 also includes an icon (818) that provides a hyperlink to a speech presentation of the article entitled ‘Trade in Major League Baseball.’ The enhanced web page (814) of FIG. 7 also includes an icon (820) that provides a hyperlink to a speech presentation of the article entitled ‘EPA Makes Announcement.’

Exemplary embodiments of the present invention are described largely in the context of a fully functional computer system for enhancing an existing web page. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of enhancing an existing web page, the method comprising:
retrieving a web page;
identifying a hyperlink within the web page;
retrieving content by invoking the hyperlink;
creating a speech presentation of the content accessible through the hyperlink;
storing the speech presentation;
creating a new hyperlink to the speech presentation; and
augmenting the web page to include the new hyperlink.

2. The method of claim 1 further comprising making the augmented web page available at a network address.

3. The method of claim 1 wherein:
identifying a hyperlink within the web page further comprises searching the hyperlink for an href element in the web page; and
retrieving content by invoking the hyperlink further comprises identifying a network address associated with the href element and retrieving the content from the network address.

4. The method of claim 1 wherein creating a speech presentation of the content further comprises:
extracting text from the content;
converting the text to speech;
creating a media file; and
recording the speech in the audio portion of the media file.

5. The method of claim 1 wherein augmenting the web page to include a new hyperlink to the speech presentation of the content further comprises adding an icon next to the hyperlink web page.

6. The method of claim 1 further comprising downloading the enhanced web page to a browser.

7. The method of claim 1 further comprising storing the speech presentation on a portable digital media player.

8. A system of enhancing an existing web page, system comprising:
a computer processor;
a computer memory operatively coupled to the computer processor;
the computer memory having disposed within it computer program instructions capable of:
retrieving a web page;
identifying a hyperlink within the web page;
retrieving content by invoking the hyperlink;
creating a speech presentation of the content accessible through the hyperlink;
storing the speech presentation;
creating a new hyperlink to the speech presentation; and
augmenting the web page to include the new hyperlink.

9. The system of claim 8 wherein:
computer program instructions capable of identifying a hyperlink within the web page further comprise computer program instructions capable of searching the hyperlink for an href element in the web page; and
computer program instructions capable of retrieving content by invoking the hyperlink further comprise computer program instructions capable of identifying a network address associated with the href element and retrieving the content from the network address.

10. The system of claim 8 wherein computer program instructions capable of creating a speech presentation of the content further comprise computer program instructions capable of:
extracting text from the content;
converting the text to speech;
creating a media file; and
recording the speech in the audio portion of the media file.

11. The system of claim 8 wherein computer program instructions capable of augmenting the web page to include a new hyperlink to the speech presentation of the content further comprise computer program instructions capable of adding an icon next to the hyperlink in the web page.

12. The system of claim 8 wherein the computer memory also has disposed within it computer program instructions capable of downloading the enhanced web page to a browser.

13. The system of claim 8 wherein the computer memory also has disposed within it computer program instructions capable of rendering the speech presentation including invoking the new hyperlink.

14. The system of claim 8 wherein the computer memory also has disposed within it computer program instructions capable of storing the speech presentation on a portable digital media player.

15. A computer program product of enhancing an existing web page, the computer program product embodied on a computer-readable medium, the computer program product comprising:
computer program instructions for retrieving a web page;
computer program instructions for identifying a hyperlink within the web page;
computer program instructions for retrieving content by invoking the hyperlink;
computer program instructions for creating a speech presentation of the content accessible through the hyperlink;
computer program instructions for storing the speech presentation;
computer program instructions for creating a new hyperlink to the speech presentation; and
computer program instructions for augmenting the web page to include the new hyperlink.

16. The method of claim 15 wherein:
computer program instructions for identifying a hyperlink within the web page further comprise computer program instructions for searching the hyperlink for an href element in the web page; and
computer program instructions for retrieving content by invoking the hyperlink further comprise computer program instructions for identifying a network address associated with the href element and retrieving the content from the network address.

17. The computer program product of claim 15 wherein computer program instructions for creating a speech presentation of the content further comprise:
computer program instructions for extracting text from the content;
computer program instructions for creating a media file;
computer program instructions for converting the text to speech; and
computer program instructions for recording the speech in the audio portion of the media file.

18. The computer program product of claim 15 wherein computer program instructions for augmenting the web page to include a new hyperlink to the speech presentation of the content further comprise computer program instructions for adding an icon next to the hyperlink web page.

19. The computer program product of claim 15 wherein the computer-readable medium further comprises a recording medium.

20. The computer program product of claim 15 wherein the computer-readable medium further comprises a transmission medium.
